(19) United States
(12) Patent Application Publication
(10) Pub. No.: US 2026/0355580 A1
(43) Pub. Date: Nov. 12, 2026

(54) MODULAR FLUKED AXE HEAD FOR ENHANCED SELF-ARREST IN VARIABLE SNOW CONDITIONS WITH A FOLD-OUT ICE PICK

(71) Applicant: John C. Martin, Midvale, UT (US)

(72) Inventor: John C. Martin, Midvale, UT (US)

(21) Appl. No.: 19/204,439

(22) Filed: May 9, 2025

(51) Int. Cl. A63B 29/08; B25F 1/00

(52) U.S. Cl. CPC A63B 29/08; B25F 1/006

(57) ABSTRACT

A modular self-arrest device for variable snow conditions features a fluked head permanently affixed to a standalone shaft. This fluked geometry provides progressive snow engagement for enhanced drag, compaction, and resistance in soft snow. Side wings improve shear resistance and increase surface area. An integrated ice pick, configurable as fold-out, retractable, or fixed, enables penetration in firm snow or ice. A dual-point clamping system on the shaft allows optional attachment to a ski or trekking pole without obstructing their normal use. When initially placed and secured via a wrist strap, the fluke's self-setting geometry may enable continued braking even if the user becomes incapacitated, provided the device is properly positioned and tethered prior to a fall. This design eliminates the need for a separate ice axe while offering adaptability, enhanced safety, and lightweight efficiency for mountaineering and backcountry travel.

### CROSS-REFERENCE TO RELATED APPLICATIONS

This application claims the benefit of U.S. Provisional Patent Application No. 63/767,264, filed on Mar. 5, 2025, which is incorporated herein by reference in its entirety.

### PRIOR ART

Traditional ice axes and attachments have been effective in aiding self-arrest, especially in hard snow and icy terrain. However, they often fail to provide reliable performance in variable or soft snow conditions, such as slush, spring snow, or mixed terrain.

U.S. Pat. No. 6,378,153 B1 (Morgan) discloses a shovel-style attachment designed to increase surface area and drag during self-arrest by attaching to a standard ice axe. While this design offers some increased resistance, it lacks the progressive fluke geometry necessary to optimize compaction and shear engagement in softer snow. Moreover, Morgan's design requires constant user input—the user must apply ongoing pressure for the device to generate sufficient resistance. Furthermore, the shovel design in Morgan lacks the ability to serve as a reliable static anchor. It must be actively held in place to resist dislodgement and cannot passively maintain resistance under load. In contrast, the present invention's fluked geometry enables self-burying and increased holding under tension, making it suitable as a static snow anchor.

In contrast, the current invention uses a progressive engagement fluked design that self-drives deeper into the snow as force is applied during a fall. This creates increasing drag and holding power without the need for constant downward pressure from the user as the design naturally “sets” itself in the snow, providing significantly improved resistance with less physical effort.

European Patent EP0056212B1 discloses a ski pole with an integrated ice axe head located on top of the grip area. While this design introduced the concept of combining an ice tool with a pole for self-arrest on steep slopes, it lacks the increased resistance the fluke-based geometry provided by the present invention. Additionally, EP005622B1 does not address performance in variable or soft snow conditions as ice picks are generally functional in hard snow or ice. The present invention offers a significant advancement by integrating a fluked geometry optimized for soft snow arrest, modular mounting options, and adaptable ice pick as needed when there is hard snow or ice.

Additionally, no known prior art incorporates a fold-out or retractable ice pick into a fluked self-arrest tool. Currently, traditional ice axes are the only self-arrest tools available and are designed specifically for hard snow and ice. There are no purpose-built self-arrest devices effective in soft or spring snow. Users are often forced to compromise or carry redundant tools. The present invention addresses this gap by integrating both a fluked engagement system and a fold-out or retractable ice pick into a single modular unit, expanding functionality across all snow conditions while reducing carried gear.

### BACKGROUND OF THE INVENTION

Mountaineering and backcountry travel present diverse challenges, requiring specialized tools for both safety and efficiency. Traditional ice axes, designed primarily for self-arrest on hard snow and ice, often prove inadequate in softer, variable conditions such as springtime snow, slush, or mixed layers. In these environments, their narrow contact points fail to generate sufficient drag or shear resistance, creating a significant safety hazard for users.

Attempts to improve self-arrest in soft snow have included retrofitted shovel-style attachments, such as those described in U.S. Pat. No. 6,378,153 B1 (Morgan). While these additions increase surface area to enhance resistance, they typically lack the progressive fluke geometry required for optimal engagement with the snowpack. Morgan's design mounts to a standard ice axe, but when hard snow or ice is encountered, the user must manually unscrew and remove the shovel attachment to access the underlying ice pick. This process may take a minute or more and is impractical in the field—particularly during a rapid transition from soft to firm snow, such as when descending shaded slopes or encountering residual ice or other icy surfaces. The present invention addresses this limitation with an integrated fold-out ice pick that locks securely into place using a hinge mechanism. This configuration allows users to quickly deploy the ice pick, often in under two seconds, without the need for tools or disassembly, whenever firm snow or ice is encountered, such as in early morning conditions, shaded areas, or wind-hardened terrain. While the fold-out ice pick is not intended to be deployed during an uncontrolled fall, its quick-access design makes it far more practical than previous systems for adapting to changing terrain while hiking, skiing, or snowboarding. Furthermore, even if the ice pick penetrates deeply into the snow, the fluked head remains fully functional, progressively engaging with the snowpack to generate drag and resistance. This layered functionality ensures effective arrest performance whether the ice pick, the fluke, or both are in contact with the snow.

Moreover, conventional self-arrest tools assume the user remains conscious and physically capable of positioning or pressing the device against the snow surface. In critical scenarios—such as rockfall, sudden loss of consciousness, or incapacitation due to injury—traditional tools may offer no protection. The present invention addresses this shortcoming by employing a fluked head with passive self-setting geometry. When initially placed into the snow by a conscious user, the fluke begins to engage with the snowpack. In soft or variable snow conditions, this geometry progressively embeds and increases resistance as the device is pulled, allowing it to continue plowing and slowing the user even if they become unable to maintain active pressure.

In firmer snow or ice, the ice pick provides the initial braking force and functions similarly to a traditional ice axe, requiring continuous user input to remain effective. However, if conditions transition and the snow becomes soft enough for the ice pick to penetrate more deeply, the fluked head will begin to engage and take over the arresting function. This layered interaction ensures that the device remains functional across a wide range of snow conditions, with the ice pick supporting firm surfaces and the fluke enabling passive deceleration in softer terrain.

Furthermore, existing tools such as Morgan's shovel-style attachment are not suited for use as static anchors. Their reliance on continuous user input to maintain snow engagement makes them prone to dislodgment under load. This significantly limits their application in scenarios where a passive or semi-permanent snow anchor is needed, such as rope belays or emergency anchor systems. The absence of self-setting geometry and inadequate resistance to upward forces renders them unreliable for anchoring in soft or variable snowpacks.

Currently, no specialized self-arrest tool exists for soft or spring-like snow conditions. The only tool widely available for this purpose is the traditional ice axe, which is fundamentally mismatched to soft snow environments. These axes are optimized for penetration and braking in hard snow or ice, but their narrow picks fail to generate sufficient resistance in softer terrain. As a result, users are left with inadequate arrest performance in soft snow, without any alternative tools specifically designed for those conditions. This gap in available equipment poses a significant safety risk during backcountry travel in spring or transitional snowpacks.

The present invention addresses these limitations by offering a purpose-built, standalone self-arrest tool featuring a fluked head optimized for progressive engagement in soft snow, combined with a fold-out or retractable icepick for effective use in firmer snow or ice. The device functions independently with its own shaft or can optionally be mounted to a ski pole or other shaft using a dual-point clamp designed to fit predefined locations. This dual-mode functionality eliminates the need to carry a traditional ice axe, streamlining the user's gear while improving safety across a broader range of conditions.

Although the device is primarily designed for self-arrest in snow, its structural geometry and durable construction may also enable secondary uses such as loosening topsoil or shallow ground plowing in non-snow environments

### SUMMARY OF THE INVENTION

The present invention provides an all-in-one self-arrest tool designed specifically for use in soft or inconsistent snow conditions, such as those commonly encountered during springtime mountaineering. Unlike traditional ice axes, which underperform in soft terrain due to their narrow picks and limited surface area, this device incorporates a fluked head with a convex triangular geometry that progressively engages with the snowpack to generate enhanced drag, compaction, shear, and displacement resistance.

To provide versatility across a range of snow conditions, the invention includes an integrated ice pick, which may be either retractable (e.g., fold-out) or fixed in length. When extended, the pick functions similarly to a traditional ice axe, enabling effective engagement with hard snow or ice. When retracted—or in the absence of a pick—the fluked geometry serves as the primary contact surface, optimized for self-arrest in softer snow. This dual-functionality allows users to carry a single, adaptable tool instead of multiple devices tailored to specific terrain types. In certain embodiments, the device may include a fixed-length pick that extends approximately 3 to 5 inches from the fluked head. This configuration eliminates moving parts, thereby enhancing reliability and reducing manufacturing complexity while still providing effective performance in firmer snow conditions. Critically, the integration of the ice pick, whether fixed, fold-out, or other retractable forms, eliminates the need to carry a separate traditional ice axe, thereby reducing overall gear weight and simplifying loadout for backcountry travel. The preferred embodiment features a fold-out ice pick mounted with a reinforced hinge, while alternate configurations may include a telescoping or multi-length extension mechanism.

The fold-out ice pick is connected to the fluked head by a reinforced hinge mechanism engineered for extreme durability. This hinge is designed to withstand high-impact forces, such as striking rocks or dense ice during a fall, and is critical to the device's safety function. The reinforced construction ensures the pick remains securely deployed when extended, preserving the tool's integrity and effectiveness under demanding self-arrest conditions.

The device can be used as a standalone unit with a dedicated shaft or configured as a modular attachment to a ski pole or trekking pole. A clamp mechanism with two predefined connection points ensures secure and stable attachment by preventing unwanted rotation or shifting during use, while still accommodating common shaft diameters used in backcountry travel.

This combination of a fluke specifically designed for soft snow, a fold-out or retractable ice pick for hard snow and ice, and an optional ski pole-mounted configuration offers a first-of-its-kind solution to a critical gap in mountaineering safety equipment.

In addition to self-arrest, the fluked geometry of the present invention also enables use as a static snow anchor. When placed under tension, the flukes self-bury and resist upward displacement, offering reliable holding power without requiring constant user pressure. This makes the device suitable for temporary anchoring applications, particularly when used in multiples or in conjunction with rope systems during mountaineering or rescue operations.

Additionally, the device's fluke geometry and durable construction may be adapted for non-snow applications such as loosening topsoil or performing shallow ground plowing, further extending the tool's functional range beyond alpine environments.

### BRIEF DESCRIPTION OF THE DRAWINGS

FIG. 1 is a perspective view of the modular fluked self-arrest device as a standalone unit, clearly illustrating the robust fold-out ice pick fully extended. Emphasis is placed on the hinge and support mechanism, both designed for durability under significant impacts.

FIG. 2A is a side view showing the fluked head with the fold-out ice pick in the retracted position.

FIG. 2B is a corresponding side view with the ice pick fully extended, illustrating the locking hinge and support geometry. Both views depict the optimized triangular structural reinforcement between the fluke head and shaft, illustrating the bonding between these components.

FIG. 3 is a top view clearly illustrating the fluke head's curvature and upward-projecting side wings.

FIG. 4 is a detailed view of the dual clamp mechanism, attached to a ski or trekking pole just below the grip, clearly demonstrating versatility and secure engagement across various pole diameters.

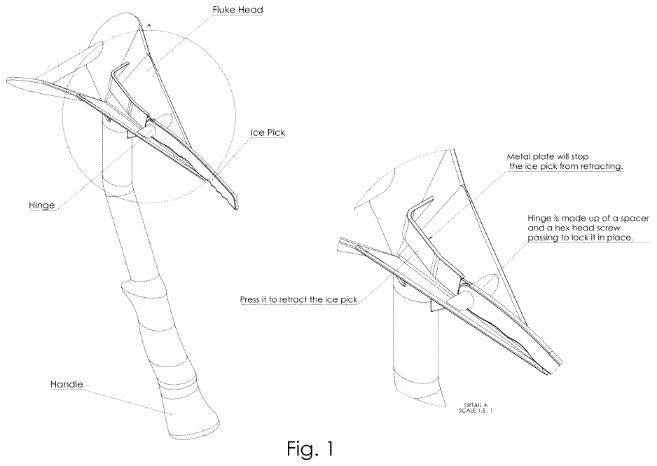

### DETAILED DESCRIPTION OF THE INVENTION

The present invention relates to a modular self-arrest tool comprising a fluked head with integrated ice pick functionality, designed for use in variable snow conditions. The device is intended for mountaineering, ski touring, backcountry travel, and related activities where lightweight and multifunctional safety equipment is essential.

The fluked head features a convex, generally triangular profile configured to maximize resistance through progressive engagement with snow. As the user applies force during a fall or when placed under load, the fluke geometry promotes shear, compaction, displacement, and frictional resistance. The side wings project upward and outward from the central fluke body to increase contact area and generate additional resistance against snow displacement. These features enable the device to self-set and maintain resistance even in softer snow conditions, where traditional ice axes are often ineffective.

The device is designed for modular attachment to either a ski pole or a trekking pole. Attachment is facilitated via a dual-point quick-release clamping system, such as two cam-operated lever mechanisms. The top clamp is positioned just below the pole's handle to prevent upward slippage during use. These mechanisms generate strong clamping force, enabling secure fixation to the pole shaft while allowing rapid, tool-free attachment and removal. The clamp system accommodates common shaft diameters and is aligned with predefined locations to minimize rotation and shifting during self-arrest.

To expand functionality into hard snow or icy conditions, the fluked head includes an integrated ice pick. In one embodiment, the pick is fold-out or retractable and housed within the head or shaft, allowing it to be extended when needed and retracted when engaging soft snow. In another embodiment, the pick is fixed in length, extending approximately 3 inches beyond the front of the fluked head. This fixed configuration eliminates moving parts, improving mechanical reliability and reducing manufacturing complexity, while still enabling effective engagement in firm snow or ice.

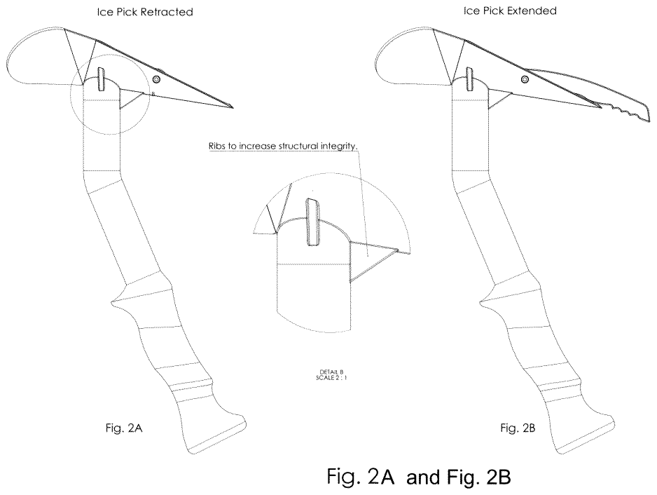

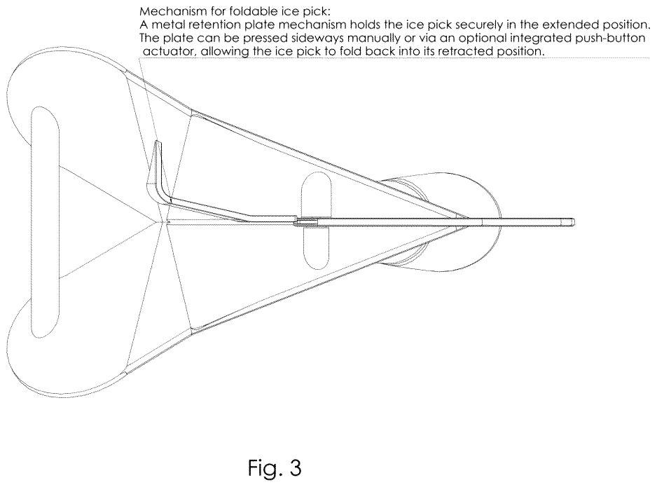

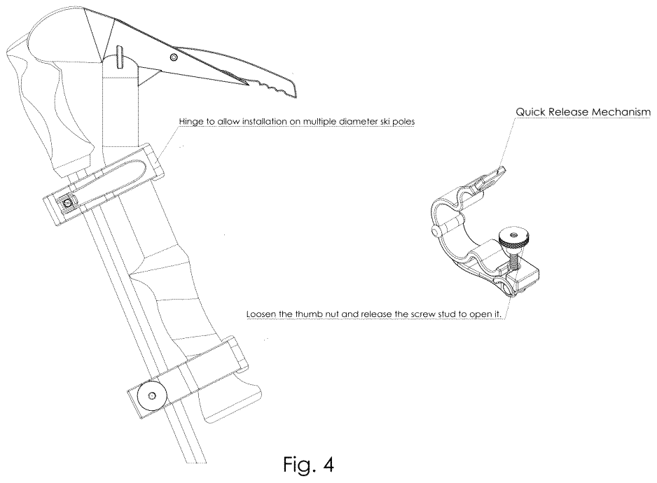

In configurations utilizing a fold-out ice pick, the pick is connected to the fluked head via a hinge assembly engineered for high durability and impact resistance. As illustrated in FIGS. 2A and 2B, the hinge enables the ice pick to transition between a fully retracted position (FIG. 2A), in which it is stowed against or within the fluked head, and a fully extended and locked position (FIG. 2B) for use in firm snow or ice. The hinge may incorporate reinforced pivot pins, locking mechanisms, and housing supports constructed from high-strength metals or composites. This assembly is specifically designed to withstand substantial forces, such as those generated during high-speed falls or direct contact with hard snow, ice, and embedded rocks. The robustness of the hinge is critical to user safety, ensuring the pick remains reliably deployed under extreme conditions without risk of structural failure. Additionally, both figures illustrate the triangular structural reinforcement between the fluked head and the shaft, highlighting the bonding geometry that enhances overall strength and resistance to torque during use.

In certain embodiments, the fold-out ice pick mechanism may incorporate a manual release system to facilitate easier transition between the extended and retracted positions. This release system may include a retention plate that holds the ice pick securely in the extended position during use. To retract the ice pick, the user may manually press the retention plate aside or, in alternative embodiments, actuate a push-button mechanism that disengages the retention plate. The push-button actuator may be positioned for easy access and designed to improve ergonomic operation, while also contributing to the aesthetic appearance of the device. The inclusion of a push-button mechanism is optional and intended to provide convenience without compromising structural integrity or reliability under load.

In an alternative configuration, the device may be supplied as a standalone unit affixed to a dedicated shaft. The shaft may be constructed from high-strength materials such as 7075-T6 aluminum alloy, high-grade stainless steel, or carbon-reinforced composites, and includes an ergonomic grip and wrist leash for enhanced control. In this embodiment, the fluked head is permanently secured to the shaft using structural welding, mechanical fasteners, or other reinforcement methods designed to withstand dynamic loads and impact forces common in alpine environments.

While the present embodiment is optimized for a balance of portability and functionality, alternative versions of the device may be manufactured in larger sizes to provide increased surface area and stopping power. These larger configurations may be specifically suited for use as dedicated snow anchors or for higher-load applications, such as group belays or hauling systems in rescue scenarios.

In certain embodiments, the standalone shaft includes an integrated attachment point located at or near the bottom of the shaft. This attachment point may be formed as a through-hole sized to accept a standard climbing carabiner or cord, facilitating the use of the device as a snow anchor when connected to rope systems or belay setups.

In scenarios where the user becomes incapacitated—such as from head trauma or environmental hazards—the wrist leash maintains the connection between the user and the device. As the fluked head drags through the snow, its self-setting geometry allows it to embed progressively, creating drag and potentially arresting the fall without requiring active user input beyond the initial placement of the device on the snow surface.

In addition to its self-arrest function, the geometry of the fluked head permits use as a passive snow anchor. When embedded and subjected to tension—such as from a rope system or belay line—the fluke's progressive engagement resists upward and lateral displacement, analogous to the behavior of a Deadman-style snow anchor. This functionality may be enhanced by using multiple units in tandem or burying the head at a strategic angle relative to the snow surface.

The modular nature of the invention allows users to configure the device based on terrain and preference, selecting between pole-mounted and standalone configurations, and between fold-out, retractable, or fixed-length pick variants. This versatility, combined with enhanced performance in soft snow and reduced gear requirements, distinguishes the invention from traditional ice axes and previously known snow-engagement tools.

In alternative embodiments, the fluked arresting mechanism may be adapted for integration into snow braking systems used with sleds or other snow-traversing equipment. These may include, but are not limited to, recreational sleds, utility sleds, or dog-pulled sleds. While the current design is optimized for human use in self-arrest or anchoring scenarios, the underlying fluked geometry may be incorporated into fixed or fold-out or retractable drag systems mounted to sleds or similar vehicles to assist with speed control and braking on snow-covered terrain.

In some embodiments, a larger fluke may be configured to nest over the standard-sized fluke using a snap-fit or locking mechanism. This configuration allows for rapid field adaptation by increasing surface area and drag characteristics when additional braking force is required, such as during snow anchor deployment or in high-load arrest scenarios.

In additional alternative embodiments, the fluked head may be adapted for non-snow applications, such as loosening soil or performing shallow ground plowing. The device's geometry can be configured to penetrate and lift soil layers, facilitating tasks like seedbed preparation, weed removal, or trail maintenance, similar to traditional handheld tools such as hoes or hand plows.

1. A modular self-arrest device for use in variable snow conditions comprising:
a. a fluked head having a convex triangular geometry configured for progressive engagement and self-setting in snow, generating increased drag and resistance under load;
b. at least one side wing projecting upward and outward from the fluked head, configured to increase snow compaction and shear resistance;
c. a dedicated shaft permanently affixed to the fluked head using structural welding and reinforcement, forming a standalone self-arrest unit;
d. an integrated ice pick operably connected to the fluked head, the ice pick being configurable between a retracted position and an extended position for engagement with hard snow or ice, wherein the ice pick is implemented in one of:
i. a fold-out configuration having a single extended length; or
ii. a configuration with multiple selectable lengths; and
e. a clamping system integrated onto the dedicated shaft, configured to selectively secure the standalone self-arrest unit to a ski pole or trekking pole, allowing normal functional use of the pole while providing immediate availability of the self-arrest device in the event of a fall.

2. The device of claim 1, wherein the ice pick is pivotally mounted to the fluked head and configured to fold out into a single fixed-length extended position, as shown in FIG. 2B, and to retract into a stowed position, as shown in FIG. 2A.

3. The device of claim 2, wherein the ice pick retention mechanism includes a manual push-button actuator configured to selectively disengage a retention plate, thereby permitting the ice pick to transition between the retracted and extended positions.

4. The device of claim 1, wherein the ice pick is implemented in an alternative embodiment as an extendable component configured to lock at one of multiple selectable lengths, allowing adjustment based on terrain or snow conditions.

5. The device of claim 1, wherein the side wings extend at an angle between approximately 10 to 45 degrees relative to the fluked head's central plane, optimized for maximum snow compaction and drag resistance.

6. The device of claim 1, wherein the fluked head is attached to the standalone shaft by structural attachment means configured to withstand dynamic and impact forces encountered in alpine environments.

7. The device of claim 1, further comprising an attachment point located at or near the bottom of the standalone shaft, configured as a through-hole sized to receive a climbing carabiner or cord for anchoring purposes.

8. The device of claim 1, wherein the standalone shaft comprises high-strength aluminum alloy, carbon fiber composite, or combinations thereof, and further comprises an ergonomic grip and wrist leash configured to maintain connection between the device and a user.

9. The device of claim 1, wherein the wrist leash maintains connection between the user and the fluked head, enabling passive self-arrest capability if the user becomes incapacitated during a fall.

10. The device of claim 1, wherein the fluked head geometry enables use as a passive snow anchor, configured to self-bury under tension and maintain resistance against displacement without continuous user input.

11. The device of claim 1, wherein a plurality of said devices are configured for combined use as a temporary snow anchor or belay system.

12. The device of claim 1, wherein the fluked head is scalable in size to increase snow engagement surface area for use in dedicated anchor configurations.

13. The device of claim 1, wherein a larger fluke is configured to attach over a standard fluke using a snap-fit or locking mechanism to increase snow engagement surface area for anchoring or high-load arrest applications.
